(19) United States
(12) Patent Application Publication
(10) Pub. No.: US 2009/0311881 A1
(43) Pub. Date: Dec. 17, 2009

(54) Split Plug Electrical Connector for Towing

(75) Inventor: David Dilgard, Phoenix, AZ (US)

Correspondence Address: TIFFANY & BOSCO;CAMELBACK ESPLANADE II, THIRD FLOOR, 2525 EAST CAMELBACK ROAD, PHOENIX, AZ, 85016, US

(73) Assignee: U-HAUL INTERNATIONAL, INC., Phoenix, AZ (US)

(21) Appl. No.: 12/136,983

(22) Filed: Jun. 11, 2008

(51) Int. Cl. H01R 33/00

(52) U.S. Cl. 439/35

(57) ABSTRACT

An apparatus is provided for simultaneously coupling a towing vehicle energizing circuit to a tow-dolly lighting circuit and a towed-vehicle lighting circuit. The apparatus includes a unitary connector body having a first portion for mating with an output plug of the towing vehicle energizing circuit, a second portion for mating with an input plug of the tow-dolly lighting circuit, and a third portion for mating with an input plug of the towed-vehicle lighting circuit. The connector body includes a plurality of conductors, each of which connects a terminal in the connector body first portion to corresponding terminals in each of the connector body second portion and third portion. The apparatus of the invention can be used to simultaneously connect the towing vehicle energizing circuit to two trailer end 4-flat plugs, one to power-tow-dolly lights and a second to power vehicle-in-tow lights.

### BACKGROUND

This invention relates generally to vehicle electrical systems for trailer or tow-dolly towing connection. More particularly, it relates to an electrical connector that simultaneously connects a towing vehicle lighting circuit to both tow dolly lights and vehicle-in-tow lights.

Connectors for connecting a towing vehicle to trailer lights or tow-dolly lights are well known. The 4-flat plug is a common towing light connector plug configuration, and is widely used on trailers and tow-dollies. A conventional 4-flat plug has a “towing vehicle end,” which is attached to the lighting circuits of a towing vehicle, and a “trailer end,” which is part of a trailer or tow-dolly wire harness and mates to the towing-vehicle plug thereby establishing electrical connection necessary for proper operation of trailer or tow-dolly lights. FIG. 1 shows a conventional 4-flat plug configuration.

When a tow-dolly (rather than a trailer) is attached to a towing vehicle, there is a need not only for operational lights on the tow-dolly itself, but also for operational lights at the rear of the vehicle-in-tow. To provide such vehicle-in-tow lighting, it has been common to attach temporary lights to the rear of the vehicle. For example, such lights can be magnetically mounted to the vehicle trunk surface or attached to plastic flaps that hang from the vehicle trunk and are held in place by the trunk lid. These tow-lights often utilize the same 4-flat plug confirmation that is common to trailers and tow-dollies.

Because the tow-dolly 4-flat plug and the vehicle-in-tow temporary lights both must connect to the towing vehicle 4-flat plug a towing vehicle driver will sometimes elect to energize either the tow-dolly lights or the vehicle-in-tow lights, but not both. In other cases, if the driver has necessary tools and knowledge, he or she may leave the tow-dolly lights plugged in, and make splice connections to energize the vehicle-in-tow lights.

There is currently a need, therefore, for an improved apparatus that can simultaneously connect a towing vehicle lighting circuit to both tow-dolly lights and to vehicle-in-tow lights. It is an object of the present invention to provide such an apparatus.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in the appended claims.

### SUMMARY OF THE INVENTION

To achieve the foregoing objects, and in accordance with the purposes of the invention as embodied and broadly described in this document, there is provided an apparatus for simultaneously coupling a towing vehicle energizing circuit to a tow-dolly lighting circuit and a towed-vehicle lighting circuit. The apparatus includes a unitary connector body having a first portion for mating with an output plug of the towing vehicle energizing circuit, a second portion for mating with an input plug of the tow-dolly lighting circuit, and a third portion for mating with an input plug of the towed-vehicle lighting circuit. The connector body includes a plurality of conductors, each of which connects a terminal in the connector body first portion to corresponding terminals in each of the connector body second portion and third portion.

In one embodiment, the connector body comprises a molded plastic body. The connector body first portion is configured to mate with an input plug that is a 4-pin flat connector. The connector body second portion is configured to mate with an input plug of the tow-dolly lighting circuit that is a 4-pin flat plug. The connector body third portion is configured to mate with an input plug of the vehicle-in-tow lighting circuit that is a 4-pin flat plug. In this embodiment, the apparatus of the invention can be used to simultaneously connect the towing vehicle energizing circuit to one 4-flat plug to power-tow-dolly lights and a second 4-flat plug to power vehicle-in-tow lights.

### BRIEF DESCRIPTION OF THE DRAWINGS

The accompanying drawings, which are incorporated in and constitute a part of the specification, illustrate the presently preferred embodiments of the invention and, together with the general description given above and the detailed description of the preferred methods and embodiments given below, serve to explain the principles of the invention.

FIG. 1 shows a typical connector assembly known in the prior art for coupling a towing vehicle electrical harness to a trailer or tow-dolly electrical harness.

FIG. 2 depicts a connector assembly according to one embodiment of the present invention, showing a plug adaptor for simultaneously coupling a 4-pin flat towing vehicle harness plug to a 4-pin flat tow-dolly harness plug and a 4-pin flat vehicle-in-tow harness plug, wherein the adaptor has a unitary plug body.

FIG. 3 depicts a connector assembly according to a second embodiment of the present invention wherein the adaptor includes three plug bodies connected by wiring harnesses.

FIG. 4 depicts a connector assembly according to another embodiment of the present invention, showing a plug adaptor for simultaneously coupling a 5-pin flat towing vehicle harness plug to a 4-pin flat tow-dolly harness plug and a 4-pin flat vehicle-in-tow harness plug.

FIG. 5 depicts a connector assembly according to another embodiment of the present invention, showing a plug adaptor for simultaneously coupling a 6-pin round towing vehicle harness plug to a 4-pin flat tow-dolly harness plug and a 4-pin flat vehicle-in-tow harness plug.

FIG. 6 depicts a connector assembly according to another embodiment of the present invention, showing a plug adaptor for simultaneously coupling a 7-pin round towing vehicle harness plug to a 4-pin flat tow-dolly harness plug and a 4-pin flat vehicle-in-tow harness plug.

### DETAILED DESCRIPTION

Reference will now be made in more detail to presently preferred embodiments of the invention, as illustrated in the accompanying drawings. While the invention is described more fully with reference to these examples and drawings, the invention in its broader aspects is not limited to the specific details, representative devices, and illustrative examples shown and described. Rather, the description which follows is to be understood as a broad, teaching disclosure directed to persons of ordinary skill in the appropriate arts, and not as limiting upon the invention.

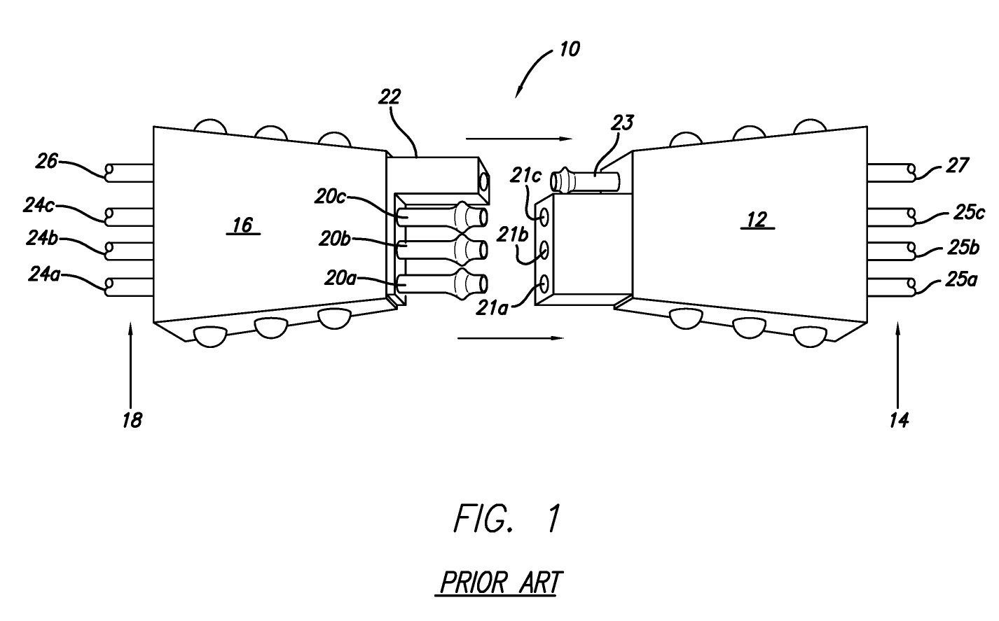

Referring now specifically to the drawings, FIG. 1 shows a typical configuration of a towing electrical connector assembly 10 for connecting the electrical systems of a towing vehicle and a tow-dolly or trailer. The connector assembly 10 includes a towing vehicle plug 12 attached to a towing vehicle electrical harness 14 and a mating trailer plug 16 attached to a trailer electrical harness 18. The towing vehicle plug 12 includes three lighting circuit pin receptacles 21a, 21b, 21c and a ground pin 23 and is configured to mate with a standard 4-pin flat trailer harness plug connected to a trailer electrical harness. Each of the lighting circuit pin receptacles 21a-c is connected to a corresponding energizing circuit wire 25a-c of the towing vehicle electrical harness 14. The ground pin 23 is connected to a ground wire 27 in the towing vehicle electrical harness 14. Each of the energizing circuit wires 25a-c is connected to a light energizing circuit of the towing vehicle (not shown) for energizing one of the tail lamp, right turn lamp and left turn lamp of the trailer. The ground wire 27 is grounded to the towing vehicle frame. The trailer harness plug 16 includes three lighting circuit pins 20a, 20b, 20c and a ground pin receptacle 22 and is configured to mate with a standard 4-pin flat towing vehicle plug connected to a towing vehicle harness. Each of the lighting circuit pins 20a-c is connected to a corresponding lighting circuit wire 24a-c of a trailer electrical harness 18. The ground pin receptacle 22 is connected to a ground wire 26 in the trailer electrical harness 18. Each of the lighting circuit wires 24a-c is connected to a lighting circuit of the trailer (not shown) for one of the tail lamp, right turn lamp and left turn lamp. The ground wire 26 is grounded to the trailer frame.

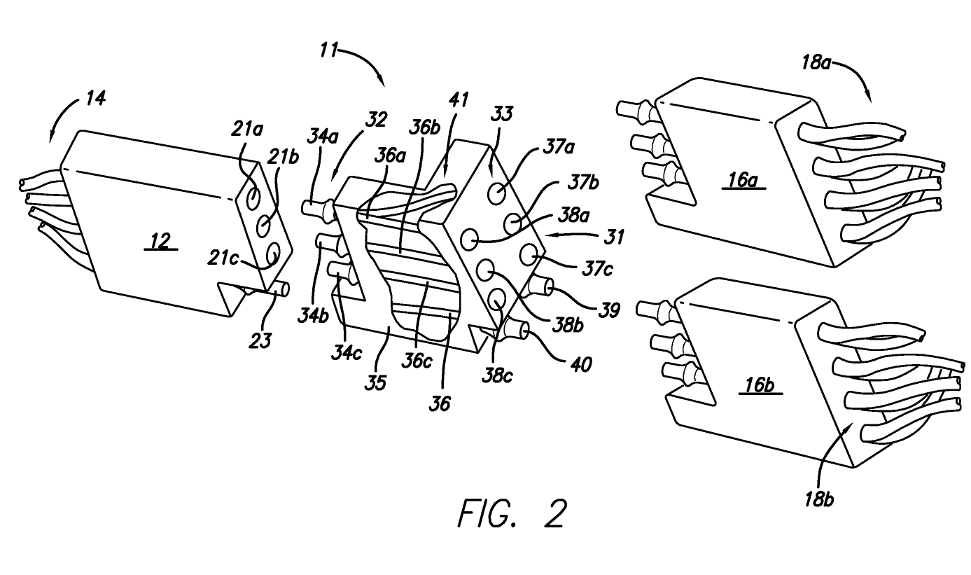

FIG. 2 shows an exemplary embodiment of a connector assembly 11 for mating a 4-pin flat towing vehicle harness plug 12 with a 4-pin flat a tow-dolly harness plug 16a and a 4-pin flat vehicle-in-tow harness plug 16b. The connector assembly 11 includes a plug adaptor 30 that has a female end 31 and male end 32. The male end 32 is configured to mate with the 4-pin flat towing vehicle harness plug 12. Adapter pins 34a, 34b and 34c and a ground receptacle 35 are disposed in the adapter male end 32 and are configured to mate with the three lighting circuit pin receptacles 21a, 21b, 21c and the ground pin 23 of the towing vehicle plug 12. The female end 31 of the adaptor 30 has a first portion 33 configured to mate with the tow-dolly harness plug 16a. Each of the pins 34a, 34b and 34c is connected to a corresponding conductor 36a-c. Conductor 36a is in turn connected to a pair of the pin receptacles 37a/38a disposed in the adapter female end first portion 33. Similarly, conductor 36b is connected to a pair of the pin receptacles 37b/38b and conductor 36c is connected to a pair of the pin receptacles 37c/38c. The ground pin receptacle 35 is connected to a ground lead 36, which in turn is connected to a ground pin 39 disposed in the adapter female end first portion 33.

Still referring to FIG. 2, the female end 31 of the adaptor 30 also has a second portion 41 configured to mate with the vehicle-in-tow harness plug 16b. Each of the pins 34a, 34b and 34c also is connected to one of the corresponding pin receptacles 38a, 38b, 38c disposed in the adapter female end second portion 41. The ground lead 36 also is connected to a ground pin 40 disposed in the adapter female end second portion 41.

In the configuration of FIG. 2, it can be seen that the adaptor 30 can be used to connect the 4-pin flat towing vehicle harness plug 12 with both the 4-pin flat a tow-dolly harness plug 16a and the 4-pin flat vehicle-in-tow harness plug 16b at the same time.

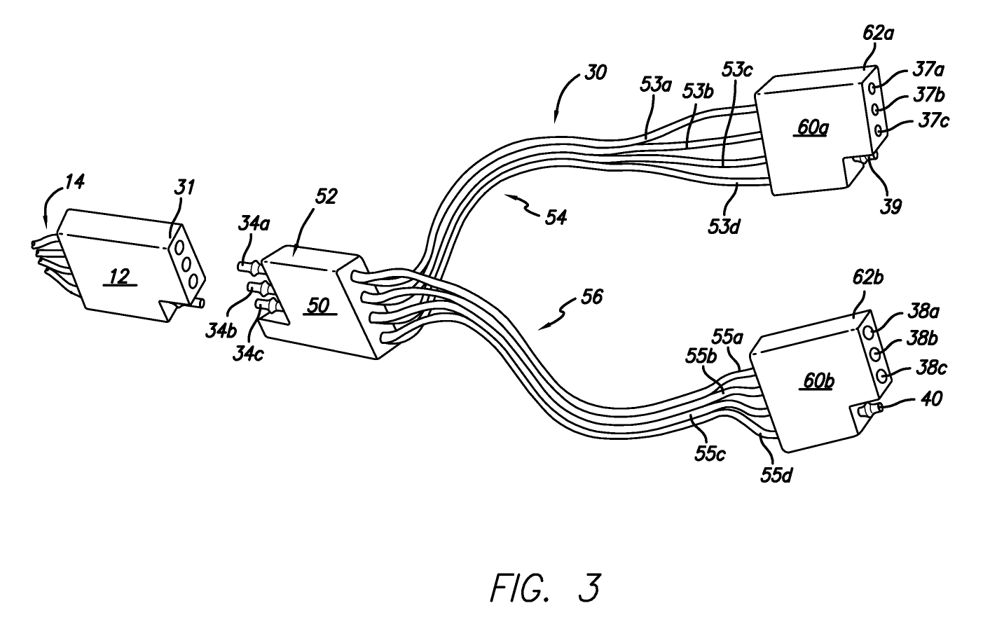

FIG. 3 shows a second exemplary embodiment of an adapter according to the present invention for connecting a 4-pin flat towing vehicle harness plug with a 4-pin flat a tow-dolly harness plug and a 4-pin flat vehicle-in-tow harness plug. The adapter 30 has a first plug 50 configured for mating with the output plug 12 of the towing vehicle energizing circuit, a second plug 60a for mating with the tow-dolly harness plug 16a and a third plug for mating with the vehicle-in-tow harness plug 16b. The first plug 50 has a male end 52 configured to mate with the 4-pin flat towing vehicle harness plug 12. Adapter pins 34a, 34b and 34c and a ground pin receptacle 35 are disposed in the adapter male end 52, as previously described. Each of the pins 34a, 34b and 34c is connected to a pair of harness wires that exit the plug 50, as described below. The second plug 60a has a female end 62a configured for mating with the input plug of the tow-dolly lighting circuit 16a. Disposed in the second plug female end 62a are pin receptacles 37a, 37b, 37c and ground pin 39. The third plug 60b has a female end 62b configured for mating with the input plug of the towed-vehicle lighting circuit 16b. Disposed in the third plug female end 62b are pin receptacles 38a, 38b, 38c and ground pin 40.

Still referring to FIG. 3, each of the pins 34a, 34b, 34c and ground pin receptacle 35 is connected to the corresponding pin receptacles 37a, 37b, 37c and ground pin 39 of the second plug 60a by corresponding conductors 53a-d of a connecting harness 54. Similarly, each of the pins 34a, 34b, 34c and ground pin receptacle 35 is connected to the corresponding pin receptacles 38a, 38b, 38c and ground pin 40 of the third plug 60b by corresponding conductors 55a-d of a connecting harness 56.

In the configuration shown in FIG. 3, the adaptor 30 can be used to connect the 4-pin flat towing vehicle harness plug 12 with both the 4-pin flat a tow-dolly harness plug 16a and the 4-pin flat vehicle-in-tow harness plug 16b at the same time.

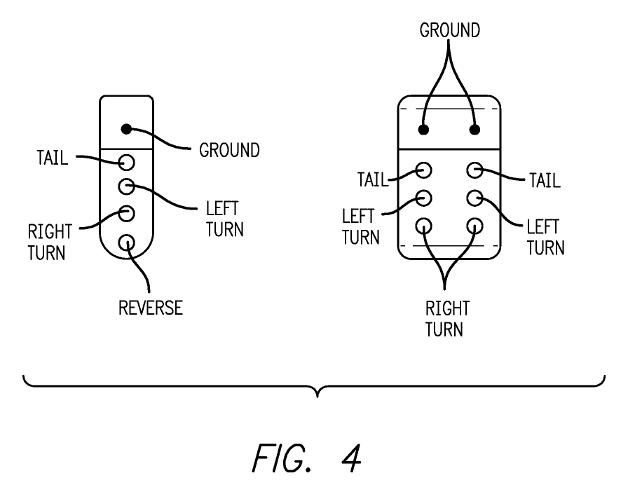

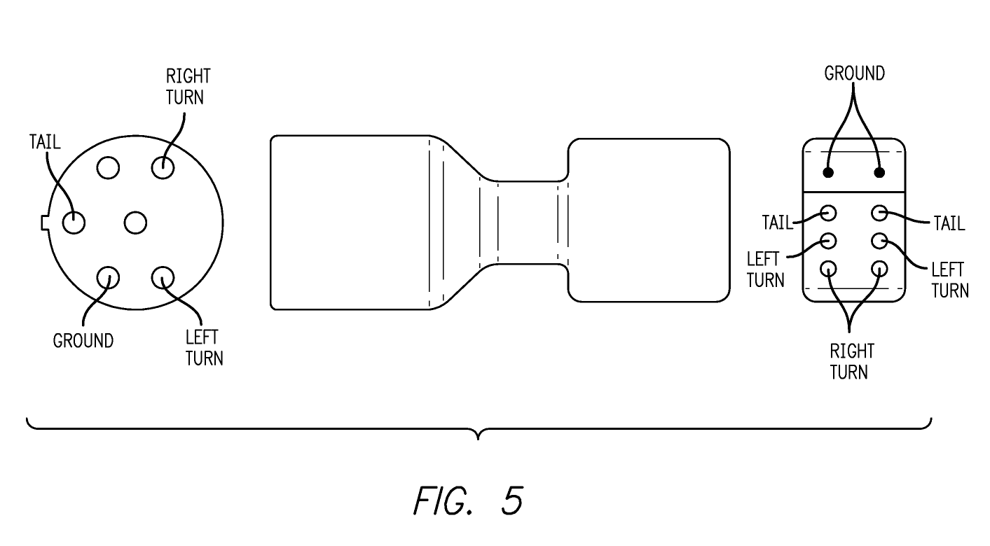

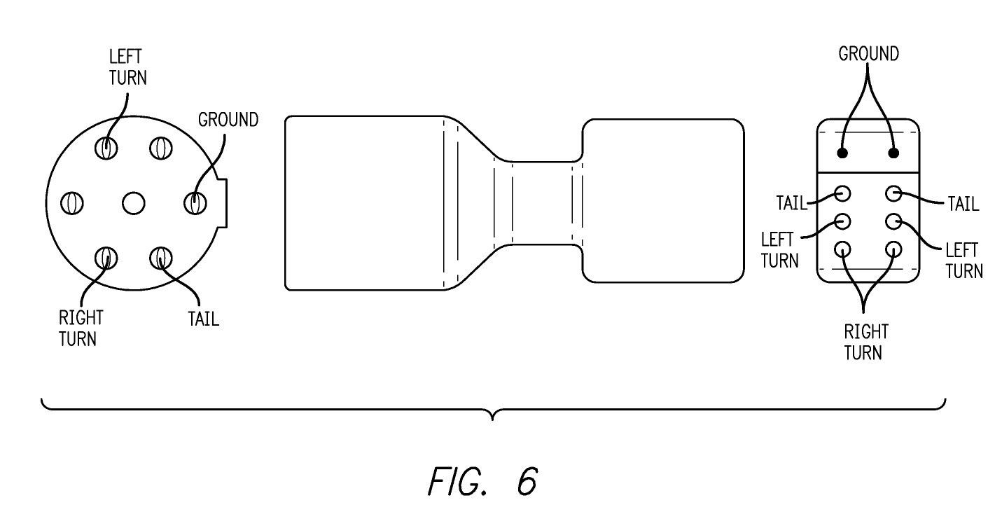

Other embodiments of connector assemblies according to the present invention can be provided for simultaneously connecting other common towing vehicle plug configurations, such as 5, 6, or 7-wire plug configurations, to a tow-dolly harness plug and a vehicle-in-tow harness plug. For example, FIG. 4 shows a connector assembly according to the present invention for connecting a 5-pin flat towing vehicle harness plug with a 4-pin flat tow-dolly harness plug and a 4-pin flat vehicle-in-tow harness plug. FIG. 5 shows an exemplary connector assembly for connecting a 6-pin round towing vehicle harness plug to a 4-pin flat tow-dolly harness plug and a 4-pin flat vehicle-in-tow harness plug. FIG. 6 shows another exemplary adapter for connecting a 7-pin round towing vehicle harness plug to a 4-pin flat tow-dolly harness plug and a 4-pin flat vehicle-in-tow harness plug. In the embodiments shown in FIGS. 4-6, it is only necessary to provide conductors 36 and 36a-c to connect to the pins of the tow-dolly and vehicle-in-tow harness plugs for the ground, left turn, right turn and tail light circuits.

From the foregoing, it can be seen that the apparatus of the present invention possesses numerous advantages. Among these, the apparatus can be used to simultaneously send towing vehicle electrical signals, such as braking and turning lights initiated from the towing vehicle, to both the tow-dolly lights and the vehicle-in-tow lights.

Upon reading this disclosure, those skilled in the art will appreciate that various changes and modifications may be made to the preferred embodiments of the invention and that such changes and modifications may be made without departing from the spirit of the invention. For example, although the connector may be designed for the most common trailer plug configuration, the 4-flat plug, any other common configuration, such as the 5, 6 or 7-wire configurations, also can be used. Therefore, the invention in its broader aspects is not limited to the specific details, representative devices, and illustrative examples shown and described. Accordingly, departures may be made from such details without departing from the spirit or scope of the general inventive concept.

1. An apparatus for coupling a towing vehicle energizing circuit to a tow-dolly lighting circuit and a towed-vehicle lighting circuit, the apparatus comprising:
a unitary connector body having a first end and a second end and a plurality of conductors;
wherein each of the plurality of conductors connects a terminal in the connector body first end to one or more terminals in the connector body second end;
wherein the connector body first end is configured for mating with an output plug of the towing vehicle energizing circuit; and
wherein the connector body second end is configured for mating with an input plug of the tow-dolly lighting circuit and for simultaneously mating with an input plug of the towed-vehicle lighting circuit.

2. The apparatus of claim 1 wherein the connector body comprises a molded plastic.

3. The apparatus of claim 1 wherein the connector body first end has three male terminal pins and a female terminal receptacle configured to mate with three terminal receptacles and a terminal pin on the output plug of the towing vehicle energizing circuit.

4. The apparatus of claim 1 wherein the connector body first end is configured to mate with a 4-pin flat connector.

5. The apparatus of claim 1 wherein the connector body second end has three female terminal receptacles and a male terminal pin configured to mate with three terminal pins and a terminal receptacle on the input plug of the tow-dolly lighting circuit.

6. The apparatus of claim 1 wherein the connector body second end has three female terminal receptacles and a male terminal pin configured to mate with three terminal pins and a terminal receptacle on the input plug of the towed-vehicle lighting circuit.

7. The apparatus of claim 1 wherein the connector body second end is configured to mate simultaneously with two 4-pin flat connectors.

8. An apparatus for coupling a towing vehicle energizing circuit to a tow-dolly lighting circuit and a towed-vehicle lighting circuit, the apparatus comprising:
a unitary connector body having a first portion for mating with an output plug of the towing vehicle energizing circuit, a second portion for mating with an input plug of the tow-dolly lighting circuit, and a third portion for mating with an input plug of the towed-vehicle lighting circuit;
wherein the connector body includes a plurality of conductors, each of which connects a terminal in the connector body first portion to corresponding terminals in each of the connector body second portion and third portion.

9. The apparatus of claim 8 wherein the connector body comprises a molded plastic.

10. The apparatus of claim 8 wherein the connector body first portion has three male terminal pins and a female terminal receptacle configured to mate with three terminal receptacles and a terminal pin on the output plug of the towing vehicle energizing circuit.

11. The apparatus of claim 8 wherein the connector body first portion is configured to mate with a 4-pin flat connector.

12. The apparatus of claim 8 wherein the connector body second portion has three female terminal receptacles and a male terminal pin configured to mate with three terminal pins and a terminal receptacle on the input plug of the tow-dolly lighting circuit.

13. The apparatus of claim 8 wherein the input plug of the tow-dolly lighting circuit comprises a 4-pin flat plug.

14. The apparatus of claim 8 wherein the connector body third portion has three female terminal receptacles and a male terminal pin configured to mate with three terminal pins and a terminal receptacle on the input plug of the towed-vehicle lighting circuit.

15. The apparatus of claim 8 wherein the input plug of the towed-vehicle lighting circuit comprises a 4-pin flat plug.

16. An apparatus for coupling a towing vehicle energizing circuit to a tow-dolly lighting circuit and a towed-vehicle lighting circuit, the apparatus comprising:
a first plug configured for mating with an output plug of the towing vehicle energizing circuit;
a second plug configured for mating with an input plug of the tow-dolly lighting circuit;
a third plug for mating with an input plug of the towed-vehicle lighting circuit; and
a plurality of conductors connecting a terminal in the first plug to a corresponding terminal in each of the second plug and the third plug.

17. The apparatus of claim 16 wherein each of the plugs comprises a molded plastic.

18. The apparatus of claim 16 wherein the first plug has three male terminal pins and a female terminal receptacle configured to mate with three terminal receptacles and a terminal pin on the output plug of the towing vehicle energizing circuit.

19. The apparatus of claim 16 wherein the first plug is configured to mate with a 4-pin flat connector.

20. The apparatus of claim 16 wherein the second plug has three female terminal receptacles and a male terminal pin configured to mate with three terminal pins and a terminal receptacle on the input plug of the tow-dolly lighting circuit.

21. The apparatus of claim 16 wherein the third plug has three female terminal receptacles and a male terminal pin configured to mate with three terminal pins and a terminal receptacle on the input plug of the towed-vehicle lighting circuit.

22. The apparatus of claim 16 wherein the third plug is configured to mate simultaneously two 4-pin flat connectors.
